(19) United States
(12) Patent Application Publication
(10) Pub. No.: US 2006/0259752 A1
(43) Pub. Date: Nov. 16, 2006

(54) Stateless Branch Prediction Scheme for VLIW Processor

(76) Inventors: Tor E. Jeremiassen, Sugarland, TX (US); Joseph R. Zbiciak, Arlington, TX (US)

Correspondence Address: TEXAS INSTRUMENTS INCORPORATED, P O BOX 655474, M/S 3999, DALLAS, TX, 75265, US

(21) Appl. No.: 11/381,614

(22) Filed: May 4, 2006

Related U.S. Application Data
(60) Provisional application No. 60/680,636, filed on May 13, 2005.

(51) Int. Cl. G06F 9/00

(52) U.S. Cl. 712/239

(57) ABSTRACT

In order to eliminate almost all the hardware cost associated with branch prediction, a new scheme for a statically scheduled VLIW Processor speculatively reads the condition for a branch one or more cycles earlier than when it can be guaranteed to be correct. This is facilitated by the fact that the branch condition is a predicate derived from the value of a general-purpose register, and stored in a separate location.

### CLAIM OF PRIORITY

This application claims priority under 35 U.S.C. 119(e)(1) to U.S. Provisional Application No. 60/680,636 filed May 13, 2005.

### TECHNICAL FIELD OF THE INVENTION

The technical field of this invention is branch prediction in programmable data processors.

### BACKGROUND OF THE INVENTION

As cycle times decrease it is necessary to increase the length of the processor pipeline. This typically most severely affects the execution of branches, by increasing the number of cycles between when a branch executes and when its target instruction executes. On a statically scheduled very-long-instruction-word (VLIW) processor with fixed branch latencies, this either necessitates the insertion of stalls or the use of a branch prediction scheme to speculatively execute the branch target instruction earlier. In addition, most branch prediction schemes require a significant amount of state information stored in an internal branch target buffer. One of these states has to be read and updated upon the execution of every conditional branch. The hardware cost is significant.

In current complex instruction set computer (CISC) machines, branch prediction logic consists of a control unit and the branch target buffer (BTB). The BTB is essentially a cache used for storing a pre-determined number of entries addressing the branch instruction. A BTB cache entry contains the target address of the branch and history bits that deliver statistical information about the frequency of the current branch. In this respect an executed branch is classified as either a taken branch or a not taken branch. Dynamic branch prediction predicts the branches according to the previous executions of that branch.

It is known in the art to assign every branch one of four conditions encoded in two history bits. The four conditions are: strongly taken; weakly taken; weakly not taken; and strongly not taken. Table 1 illustrates a typical coding.

TABLE 1

| Coding | Condition |
|---|---|
| 00 | Strongly Taken |
| 01 | Weakly Taken |
| 10 | Weakly Not Taken |
| 11 | Strongly Not Taken |

When a new branch executes, the history bits are updated based upon whether the branch is taken or not taken. For taken branches updating follows the chain from strongly not taken to weakly not-taken to weakly taken to strongly taken. For not taken branches updating follows the chain from strongly taken to weakly taken to weakly not taken to strongly not taken.

When a new entry is made in the BTB for a newly encountered branch instruction, the history bits are initialized to the weakly taken condition. This is justified because most branches encountered during execution are jumps back to the beginning of a loop.

A pre-fetch buffer and the BTB work together to fetch the most likely instruction after a branch. Branch prediction begins when the processor supplies the address of the branch instruction in the decoding stage. This is true for all instructions because a BTB hit can only occur for branch instructions. A BTB hit occurs when the address of a branch instruction matches that of a branch instruction address stored in the BTB. Upon a BTB hit the branch prediction logic delivers an address dependent upon the condition. For a strongly taken or weakly taken branch, the branch prediction logic predicts the branch will be taken and fetches the target instruction of the branch which is stored in the BTB. For a weakly not taken or a strongly not taken branch, the branch prediction logic predicts the branch will not be taken. In this case the instruction the next sequential address is fetched.

If many branch instructions occur in a program, the BTB will eventually become full. BTB misses will occur for branch instructions not already stored. A BTB miss is handled as a not-taken branch. The dynamic BTB algorithms of the processor independently take care of the reloading of new branch instructions, and predict the most likely branch target. In this way, the branch prediction logic can reliably predict the branches. Usually a conditional branch requires comparison of two numbers either explicitly through a compare or implicitly through a subtract operation.

If the prediction is correct, as is nearly always the case with unconditional branches and procedure calls which are only incorrect for old BTB entries from a different task, then all instructions loaded into the pipeline after the branch instruction are correct. Pipeline operation thus continues without interruption. In this case branches and calls are executed within a single clock cycle, and may be executed in parallel with other instructions in a VLIW processor.

If the prediction is found incorrect, the pipeline is emptied and the CPU instructs the fetch stage to fetch the instruction at the correct address. Then pipeline restarts operation in the normal way.

The use of branch prediction in VLIW DSP processors is aided by the structure of its pipelined architecture. Table 2 lists the pipeline stages and the functions of the TMS320C6000 series of digital signal processors manufactured by Texas Instruments Incorporated.

TABLE 2

| | | |
|---|---|---|
| PG | Prog Addr Generate | Determine Address of Fetch Packet |
| PS | Prog Addr Send | Sent Fetch Packet Address to |
| | | memory |
| PW | Prog Wait | Access Program memory |
| PR | Prog Data Receive | Receive Fetch Packet at CPU |
| DP | Dispatch | Determine Next Execute Packet and |
| | | sent to the appropriate |
| | | functional units |
| DC | Decode | Decode Instructions in functional |
| | | units |
| E1 | Execute1 | Read and evaluate instruction |
| | | Conditions |
| | | Load and Store: |
| | | Perform Address generation; |
| | | Write Address modifications to |
| | | register file. |
| | | Branch Instructions: |
| | | Branch fetch packet in PG phase |
| | | is affected. |
| | | Single cycle instructions: |
| | | Write Results to register file |

Program fetch is performed in four clock cycles partitioned into pipeline phases PG, PS, PW, and PR. Program decode includes the DP and DC pipeline phases. Most program execution occurs in the E1 pipeline phase.

FIG. 1 is a functional block diagram of a prior art VLIW digital signal processor (DSP). FIG. 1 illustrates the pipeline phases of the processor. The fetch stage 100 includes the PG phase 101, the PS phase 102, the PW phase 103 and the PR phase 104. In each of these phases the DSP can perform eight simultaneous commands. Table 3 is a summary of these commands.

TABLE 3

| Instruction | Instruction | Functional Unit |
|---|---|---|
| Mnemonic | Type | Mapping |
| STH | | D-Unit |
| SADD | Signed Add | L-Unit |
| SMPYH | Signed Multiply | M-Unit |
| SMPY | Signed Multiply | M-Unit |
| SUB | Subtract | L-Unit; S-Unit; D-Unit |
| B | Branch | S-Unit |
| LDW | Load | D-Unit |
| SHR | Shift Right | S-Unit |
| MV | Move | L-Unit |

The decode stage 110 includes the dispatch phase DP 105 and the decode phase DC 106. The DP phase and the DC phase also perform commands from Table 3.

The powerful execute stage 120 performs all other operations including: (a) evaluation of conditions and status; (b) Load-Store instructions; (c) Branch instructions; and (d) single-cycle instructions. Table 3 lists the instructions and mnemonics of those instructions included in FIG. 1 in the various pipeline phases. The functional unit mapping in Table 3 indicates the possible functional units that perform the instruction listed. The E1 phase 107 uses as operands the thirty-two 32-Bit registers included in register file A 108 and register file B 109. Addresses are stored in internal data memory 111 and these addresses are accessed via data memory and control 112.

FIG. 2 illustrates the manner in which the pipeline is filled in a VLIW DSP. Successive fetch stages can occur every clock cycle. In a given fetch packet such as fetch packet n 200, the fetch phase is completed in four clock cycles with the four pipeline phases PG 201, PS 202, PW 203 and PR 204 listed in Table 2. In fetch packet n the next two clock cycles (fifth clock cycle 205 and sixth clock cycle 206) are devoted to the program decode stage consisting of two clock cycles in which the dispatch phase DP 205 and decode phase DC 206 are completed. It is useful to label pipeline phases 202 through 206 as Branch Delay Slots because these clock cycles are used for branch operations. The seventh clock cycle 207 and succeeding clock cycles of fetch packet n are devoted to the execution of the instructions in the packet. Any additional processing that may be required in processing a given packet, if not executable in the first eleven clock cycles as indicated in FIG. 2 results in pipeline stalls or even data memory stalls.

FIG. 3 illustrates the pipelined stages of the VLIW DSP in the prior art as a fetch packet including a branch instruction advances. The prior art allows for only one wait state PW 303 between the program address send PS stage and the program data receive stage PR. Stages PS 302, PW 303, PR 305, DP 306 and DC 307 together form branch delay slots. Current VLIW DSPs have internal storage for the results of all processing of pipelined packets occurring during these delay slots. These are packets n+1 through n+5 illustrated in FIG. 2. The processor must stall if an additional packet enters the pipeline. In order for a stall not to be necessary, the branch decision must be made in the branch execute cycle E1 308 immediately following the last of the branch delay slots. This allows the computed branch target to be fetched without creating a stall bubble or empty cycle in the pipeline. However, the DSP illustrated in FIG. 3 allows for no early branch prediction based on early available status information.

With a branch instruction occurring in packet n of FIG. 2, the full set of phases for fetch packet n 200 of FIG. 2 would be expanded and modified as illustrated in FIG. 4. As the branch target begins processing in 400 it proceeds through processing steps 401 through 405 during which time processing of other fetch packets (n+1 through n+5) in the pipeline are subjected to five delay slots. When the branch target begins execution in 406 the other fetch packets in the pipeline may resume processing with the PS, PW, PR, DP and DC stages cleared for their use. This protocol for delay slots and potential stalls when a fetch packet contains more than one execute packet becomes even more complex when branch prediction techniques are included.

Two major considerations affect the implementation of branch prediction in any style of processor. First, a means must be provided to store data upon which the branch prediction might be based. This is most often some form of coded history indicating the outcome of previous branch predictions. This code history is usually stored as a large number of units containing a small number of bits describing each occurrence. As processor cycles advance, at some point the storage can be used up and then updating discards older data. Often this type of storage takes the form of an array several hundred two or three bit words. The amount of overall storage dedicated exclusively to branch prediction thus becomes very significant in the cost and complexity it adds to the chip.

The second major element in branch prediction implementation is the rules defining the strategy for making the branch prediction decision. Two strategies possible are: static branch prediction; and dynamic branch prediction. In static branch prediction, only present conditions (status) of the processor are used to make the branch prediction. In dynamic branch prediction, past history exerts a strong influence on the branch decision. Table 4 lists known rules that have been employed in static and dynamic branch prediction.

TABLE 4
Preliminary Criteria

| | |
|---|---|
| Strategy 1 | All Branches will be taken. |
| Strategy 2 | Branch will be predicted the same as |
| | its last execution. If not been |
| | previously executed, predict that it |
| | will be taken. |

STATIC Branch Prediction Criteria

| | |
|---|---|
| Strategy 1S | Predict that all branches with certain |
| | operation codes will be taken and other |
| | branches will not be taken. |
| Strategy 2S | Predict that all backward branches will |
| | be taken. |
| | Predict that all forward branches will |
| | not be taken. |

DYNAMIC Branch Prediction Criteria

| | |
|---|---|
| Strategy 1D | Maintain a table of the most recently |
| | used branch instructions that are not |
| | taken. |
| | If a branch instruction is in the |
| | table, predict that it will not be |
| | taken, else predict that it will be |
| | taken. |
| | Purge table entries of taken branches |
| | and use LRU replacement to add new |
| | entries. |
| Strategy 2D | Maintain a bit for each instruction in |
| | the cache to record if branch taken on |
| | its last execution. Branches are |
| | predicted as their last execution. If |
| | a branch has not been executed, predict |
| | it will be taken. Implement by |
| | initializing the bit cache to taken |
| | when first placed in the cache. |

### SUMMARY OF THE INVENTION

In order to eliminate almost all the hardware cost associated with branch prediction, a new scheme for a statically scheduled VLIW Processor speculatively reads the condition for a branch one or more cycles earlier than when it can be guaranteed to be correct. This is facilitated by the fact that the branch condition is a predicate derived from the value of a general purpose register, and this branch condition is stored in a separate location. The branch is predicted taken or not-taken based on the value of this early read of this branch condition, and if predicted taken, the branch prediction can be issued one or more cycles earlier in the pipeline. This effectively hides any stalls that would have to be inserted due to any lengthening of the pipeline. If the branch condition is computed far enough in advance, this scheme will predict with absolute accuracy.

### BRIEF DESCRIPTION OF THE DRAWINGS

These and other aspects of this invention are illustrated in the drawings, in which:

FIG. 1 illustrates the functional block diagram of a current VLIW DSP and illustrates the pipeline phases of the processor; (Prior Art);

FIG. 2 illustrates the time relationship between fetch packets and execute packets in a pipelined DSP when there are no stall cycles (Prior Art);

FIG. 3 illustrates the relationship between the pipelined stages prior to execution of a branch instruction and the branch delay slots (Prior Art);

FIG. 4 illustrates the manner in which the full set of phases in a fetch packet is modified when a branch instruction occurs (Prior Art);

FIG. 5 illustrates the modified pipeline for the DSP of this invention with an additional wait state added causing a stall if branch prediction is not employed; and

FIG. 6 illustrates the modified pipeline for the DSP of this invention with an additional wait state added and with branch prediction activated; no stall is necessary unless the branch decision predicted by early read of predicate registers is not correct.

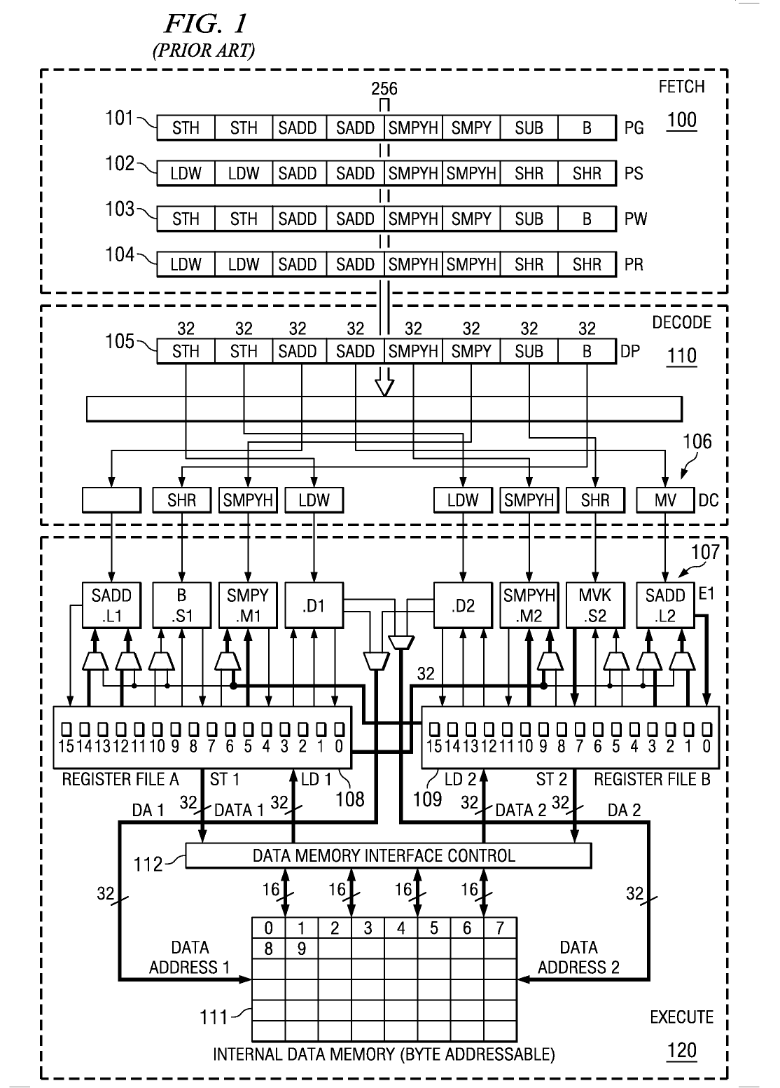

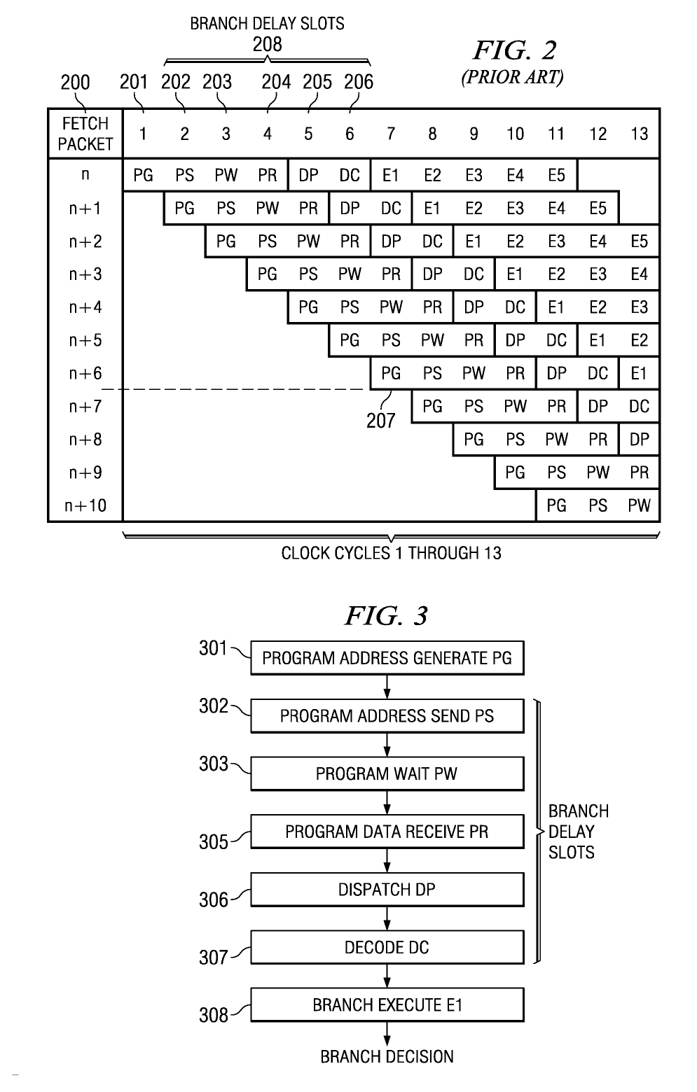

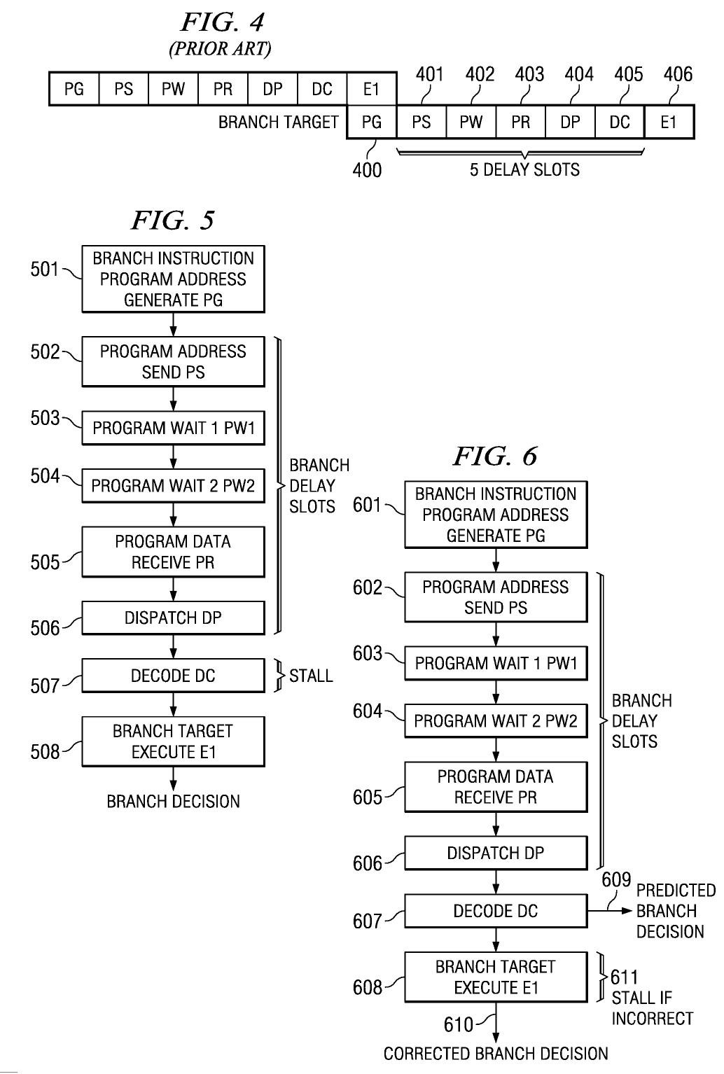

### DETAILED DESCRIPTION OF PREFERRED EMBODIMENTS

This invention presents a unique approach for branch prediction in a VLIW processor. This new scheme involves employing a speculative early read of the branch condition one or more cycles earlier than when it can be guaranteed to be correct. This is facilitated by the fact that the branch condition is a predicate derived from the value of a general-purpose register, and stored in a separate location. The branch is predicted taken or not-taken based on the value of this early read of the condition, and if predicted taken, can be issued one or more cycles earlier in the pipeline. This effectively hides any stalls that would have to be inserted due to any lengthening of the pipeline. If the branch condition is computed far enough in advance, this scheme will predict with absolute accuracy.

The present invention makes use of a special technique that is key to developing a viable and efficient branch prediction approach to alleviate the negative performance effect on branches when additional pipe stages have to be inserted in the pipeline. The technique involves the use of predicate registers to control branch execution. A predicate register stores the value of some program condition. This stored condition can be used to control the execution of instructions. Such controlled instructions are called predicated instructions. A predicated instruction only executes when the value of the controlling predicate is of a specified value, either true or false. Usually, a non-zero value indicates true and a zero value indicates false. For instance, an instruction may specify that it only executes if the value of the controlling predicate is zero (false). In particular, predicate registers may be used to control branch instructions allowing execution, and thus the branch to occur, only when the controlling predicate satisfies the specified condition.

Consider the following example of predicate register use. Programmers may dedicate one or more predicate registers to represent condition(s) in the program. These conditions could include:

(a) The value of a down-counting loop iteration counter, used by a branch instruction to control whether the branch back to the top of the loop should execute or not; and

(b) The result of a comparison of two values. Compare instructions are usually designed so that the truth value of the comparison can be written to a predicate register (1 for true, 0 for false). Comparisons can be “is equal”, “is not equal”, “is greater than”, “is greater or equal than”, etc. The condition could then be to provide a decision to branch or not to branch according to the result stored in a predicate register holding a decision on the compiled result.

FIG. 5 illustrates the pipelined stages of the VLIW processor modified according to the present the invention by in the case where one additional wait state PW2 504 has been added between the first program wait stage PW1 503 and the program data receive stage PR 505. Stages PS 502, PW1 503, PW2 504, PR 505 and DP 506 together form branch delay slots. First, assume that branch prediction is not used. The fetch packet shown begins processing of the branch instruction in the program address generate stage PG 501. Compared to processing with a conventional VLIW DSP, the packet is processed through an additional wait state PW2 504 and includes the same number of branch delay slots. Since the branch decision is not made until the cycle after the cycle immediately following the last of the branch delay slots, there is one cycle of additional latency between the execution of the branch instruction 501 and the execution of the branch target instruction 508 that cannot be masked by the branch delay slots. In order to preserve the semantics of the executing program it is therefore necessary to insert a stall cycle after the branch delay slots following the branch execution. During this stall cycle, only the PG phase of adjacent packets (e.g. packets n+1 through n+6) advance, the PS, PW1, PW2, PR, DP, and DC stages do not. This compensates for the fact that the program fetch pipeline is longer than the number of branch delay slots. However, there is a one-cycle penalty added to the execution of every branch instruction.

FIG. 6 illustrates the pipelined stages of the VLIW DSP with a fetch packet involving a branch instruction having the additional wait state 604. Stages PS 602, PW1 603, PW2 604, PR 605 and DP 606 together form branch delay slots. Also shown are the initial branch prediction 609 and the (if necessary) corrected branch prediction 610. Stage 607 predicts whether the branch will be taken or not and sends out the predicted branch decision 609. If the branch is predicted taken, the branch target address can be sent out as indicated by 609 immediately following this stage. Since the branch was determined in the cycle 607 immediately following the branch delay slots, a stall will not be required if the prediction is correct. If the prediction was not correct, an additional stall 611 will be required to compensate either for issuing a fetch for the branch target instruction 608 that should not have happened or for not fetching a branch target for a branch that should have happened. Stage 608 compares the branch prediction output of stage 607 with the actual execution of the branch and triggers the corrective stalls in case they differ.

The conditions for branching listed in Table 4 are extremely simple and are derived from the considerations listed in Table 5.

TABLE 5

| Dynamic Branch Prediction | |
|---|---|
| Criteria | Action |
| Early read of Predicate | Predict branch Taken |
| Register indicates True | |
| Early read of Predicate | Predict branch Not Taken |
| Register indicates False | |

The present invention eliminates the need for cumbersome storage of the state associated with the branch prediction scheme. Almost all known branch prediction schemes maintain a set of 512 to 2048 saturating two-bit counters that store the state associated with the branch prediction scheme. Almost all known branch prediction schemes maintain index these saturating two-bit counters by various functions of the branch address and recent taken/not-taken branch outcomes. This state attempts to capture the previous behavior of branches with the underlying assumption that this behavior will be repeated, with no regard to the current state of the application as exhibited in the content of the register file. That is, it is assumed that a branch taken frequently in the past will tend to be taken frequently in the future.

By contrast the technique of the present invention has several benefits:

(1) There is no large set of counters that have to be read and updated every cycle.

(2) The branch prediction is not based on past history, but on values currently stored in the register file. This means that it is capable of adapting instantaneous to changes in the behavior of the application.

(3) If the branch condition is computed earlier, which can be done in many cases without loss of performance, the prediction is absolutely accurate.

What is claimed is:

1. A method of branch prediction in a data processor with pipelined operation including plural pipeline phases having branches conditional on the state of a predicate register comprising the steps of:
reading a predicate register state for branch instruction during pipeline phase before said state is guaranteed correct;
performing a first comparison of said early read of predicate register state with a branch condition;
predicting a conditional branch instruction taken/not taken based on said comparison;
speculatively executing a branch target instruction if predicted taken;
speculatively executing an instruction following said conditional branch instruction if predicted not taken;
reading said predicate register state for branch instruction during pipeline phase when said state is guaranteed correct;
performing a second comparison of said predicate register state with said branch condition; and
confirming or disaffirming said branch prediction based on said second comparison.

2. The method of branch prediction of claim 1, further comprising the step of:
calculating a predicate register state in advance of when said state is guaranteed to be correct.

3. The method of branch prediction of claim 2, further comprising the step of:
calculating a predicate register state before a pipeline phase of said early read of said predicate register state.

4. The method of branch prediction of claim 1, further comprising the step of:
if a branch was predicted taken and the prediction disaffirmed, then flushing the pipeline of said branch target instruction and following instructions, and fetching an instruction following said conditional branch instruction.

5. The method of branch prediction of claim 1, further comprising the steps of:
if a branch was predicted not taken and the prediction disaffirmed, then flushing the pipeline of said instruction following condition branch instruction and following instructions, and fetching said branch target instruction.

6. The method of branch prediction of claim 1, wherein:
said step of reading a predicate register state for branch instruction during pipeline phase before said state is guaranteed correct comprises reading said predicate register state during a same pipeline phase as instruction decoding.

7. The method of branch prediction of claim 1, wherein:
said step of reading said predicate register state for branch instruction during pipeline phase when said state is guaranteed correct comprises reading said predicate register state during a same pipeline phase as instruction execution.
